(19) United States
(12) Patent Application Publication
(10) Pub. No.: US 2026/0093119 A1
(43) Pub. Date: Apr. 2, 2026

(54) OPTICAL MODULE AND AUGMENTED REALITY DISPLAY WITH LOW REFRACTIVE INDEX AND LARGE FIELD OF VIEW

(71) Applicant: AUO Corporation, Hsinchu City (TW)

(72) Inventors: Yu-Ting HU, Hsinchu City (TW); Seok-Lyul LEE, Hsinchu City (TW); Ming-Jui WANG, Hsinchu City (TW); Yen-Chun CHIANG, Hsinchu City (TW); Ting-Wei TSAI, Hsinchu City (TW); Chih-Chiang CHEN, Hsinchu City (TW); Chia-Hsin Chung, Hsinchu City (TW); Hsin-Chang LIN, Hsinchu City (TW); LI-YING LIU, Hsinchu City (TW)

(21) Appl. No.: 19/337,161

(22) Filed: Sep. 23, 2025

(30) Foreign Application Priority Data
Sep. 30, 2024 (TW) 113137384

(51) Int. Cl. G02B 27/01; G02B 6/34

(52) U.S. Cl. CPC G02B 27/0172; G02B 6/34; G02B 2027/0118; G02B 2027/0123; G02B 2027/0178

(57) ABSTRACT

An optical module is disclosed, including a projection light source, a first optical waveguide, and a second optical waveguide. The projection light source is configured to provide a target image. The first optical waveguide has a plurality of first gratings. The plurality of first gratings are arranged at a distance of a first period. The second optical waveguide has a plurality of second gratings. The plurality of second gratings are arranged at a distance of a second period. An absolute value of a difference between the first period and the second period is greater than 0 and less than or equal to one tenth of a wavelength of the target image.

### CROSS-REFERENCE TO RELATED APPLICATION

This application claims the priority benefits of Taiwan patent application serial no. 113137384 filed on Sep. 30, 2024. The entirety of the mentioned above patent application is hereby incorporated by reference herein and made a part of this specification.

### TECHNICAL FIELD

The present invention relates to an optical module, and in particular, to an optical module with a low refractive index and a large field of view (FOV).

### BACKGROUND

A surface relief grating (SRG)-based optical waveguide is a fundamental configuration of augmented reality (AR) glasses, and the technological development of the AR glasses is gradually expanding into various application levels. For example, subtitle-type AR glasses with a large field of view (FOV) are provided.

However, the conventional technical means is to utilize high-refractive-index glass to expand the FOV, which results in higher manufacturing costs and increases a weight of a device. Moreover, to improve brightness of the FOV, different grating structures need to be used, which further increases manufacturing difficulty and mold costs. Therefore, how to obtain AR glasses with a large FOV and high brightness at a lower manufacturing cost, without excessively increasing the weight of the device and reducing the manufacturing difficulty, and with subtitle projection positions not occluding a forward line of sight of a user is a technical problem to be resolved.

### SUMMARY

To resolve the foregoing technical problem, an embodiment of the present invention provides an optical module, including a projection light source, a first optical waveguide, and a second optical waveguide. The projection light source is configured to provide a target image. The first optical waveguide has a plurality of first gratings, and the plurality of first gratings are arranged at a distance of a first period. The second optical waveguide has a plurality of second gratings, and the plurality of second gratings are arranged at a distance of a second period. An absolute value of a difference between the first period and the second period is greater than 0 and less than or equal to one tenth of a wavelength of the target image.

An embodiment of the present invention also provides an augmented reality (AR) display, including the foregoing optical module. Compared with the conventional technology, in the embodiments of the present invention, the target image is transmitted through an optical waveguide configured with a different grating period, so that the target image is incident onto eyes of the user at different angles, thereby expanding a field of view (FOV) of the target image. Therefore, the technical effect of AR glasses with a large FOV is achieved by not using high-refractive-index glass and without modifying the grating structure, which resolves the technical problems such as high manufacturing costs, the increased device weight, high manufacturing difficulty, and high mold costs in the conventional technology.

### BRIEF DESCRIPTION OF THE DRAWINGS

In order to make the foregoing and other purposes, features, advantages, and embodiments of the present invention clearer and easier to understand, the accompanying drawings are described below.

FIG. 1 is a schematic diagram of an architecture of an optical module according to an embodiment of the present invention.

FIG. 2 is an enlarged schematic diagram of a grating of an optical waveguide according to an embodiment of the present invention.

FIG. 3A to FIG. 3C are schematic diagrams of grating structures according to an embodiment of the present invention.

FIG. 4A is a schematic diagram of a first configuration and a size of a field of view (FOV) of an input coupling region, a folding region, and an output coupling region according to an embodiment of the present invention.

FIG. 4B is a schematic diagram of a second configuration and a size of an FOV of an input coupling region, a folding region, and an output coupling region according to an embodiment of the present invention.

FIG. 4C is a schematic top view of a percentage of overlap of an input coupling region, a folding region, and an output coupling region according to an embodiment of the present invention.

FIG. 5 is a schematic diagram of an included angle at which a user views an output coupling region according to an embodiment of the present invention.

### DETAILED DESCRIPTION

Various embodiments are to be described in this specification, and a person having ordinary skill in the art can easily understand the spirit and principles of the present invention by referring to the accompanying drawings. Herein, each element or part illustrated in each drawing may be exaggerated or changed for clarity. Therefore, a person having ordinary skill in the art should understand that the size and relative ratio of each element or part illustrated in the drawings are not actual size and relative ratio of the element or part. In addition, although some specific embodiments are to be specifically described herein, these embodiments are only illustrative and are not to be considered in a limiting or exhaustive in all aspects. Therefore, various changes and modifications of the present invention should be obvious and easily implemented for a person having ordinary skill in the art without departing from the spirit and principles of the present invention.

It should be understood that although terms “first”, “second”, “third”, and the like may be used herein to describe various elements, components, regions, layers, and/or parts, these elements, components, regions, and/or parts should not be limited by these terms. These terms are only used to distinguish one element, component, region, layer, or part from another element, component, region, layer, or part. Therefore, “first element”, “component”, “region”, “layer”, or “part” discussed below may be referred to as a second element, component, region, layer, or part without departing from the teachings herein.

In addition, conventional elements in the embodiments of the present invention are not to be described in detail or are to be omitted, so as to avoid obscuring relevant details. In the following description, for the purpose of explanation rather than limitation, specific details are set forth in the figures and specification to provide a thorough understanding of the embodiments of the present invention. However, it is apparent that the embodiments may be implemented without these specific details.

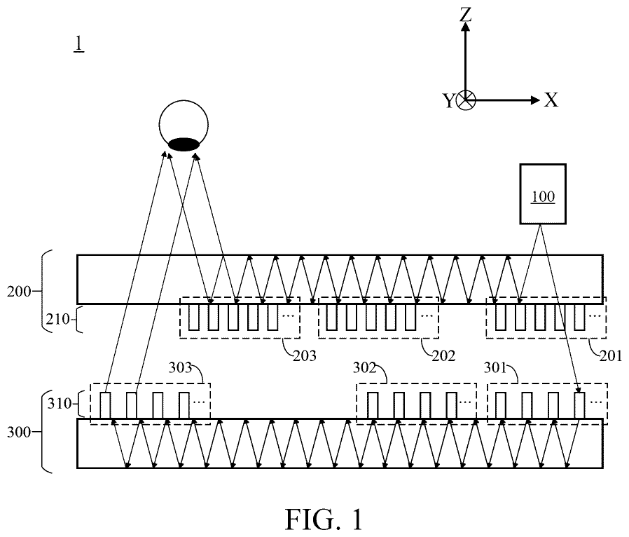

Referring to FIG. 1, FIG. 1 is a schematic diagram of an architecture of an optical module according to an embodiment of the present invention. In FIG. 1, an optical module 1 includes a projection light source 100, a first optical waveguide 200, and a second optical waveguide 300. The projection light source 100 may be a monochromatic light source or a multi-color light source to provide a target image. When the target image is transmitted to the first optical waveguide 200, the target image enters an interior of the first optical waveguide 200 through a portion of a plurality of first gratings 210 of the first optical waveguide 200 for transmission, and is transmitted from the first optical waveguide 200 through another portion of the foregoing first gratings 210 and finally to eyes of a user.

On the other hand, when the target image is transmitted to the first grating 210 of the first optical waveguide 200, the target image passes through the first optical waveguide 200 and is transmitted to the second optical waveguide 300. In addition, the target image enters an interior of the second optical waveguide 300 through a portion of the plurality of second gratings 310 of the second optical waveguide 300 and is transmitted. Then, the target image is transmitted from the second optical waveguide 300 through another portion of the foregoing second gratings 310 and finally to the eyes of the user.

During the foregoing transmission, the plurality of first gratings 210 in the first optical waveguide 200 are arranged with a first period P1, and the plurality of second gratings 310 in the second optical waveguide 300 are arranged with a second period P2. The target images are transmitted from the first optical waveguide 200 and the second optical waveguide 300, and each have a different angle range. Moreover, a target image viewed by the user is a target image with a large field of view (FOV). In other words, a size of an FOV (for example, in a range of 30 degrees) of a combined target image viewed by the user from the first optical waveguide 200 and the second optical waveguide 300 is greater than a size of an FOV (for example, in a range of 20 degrees) of a target image viewed using only a single optical waveguide.

Furthermore, the first optical waveguide 200 and the second optical waveguide 300 may be implemented as optical waveguides with a low refractive index, for example, common liquid crystal glass or plastic. In an embodiment, refractive indexes of the first optical waveguide 200 and the second optical waveguide 300 are between 1.45 and 1.65. Therefore, compared with the conventional technology, in the embodiments of the present invention, high-refractive-index materials that are relatively expensive and heavy are not necessarily used, which has the technical effect of low manufacturing costs and no additional weight.

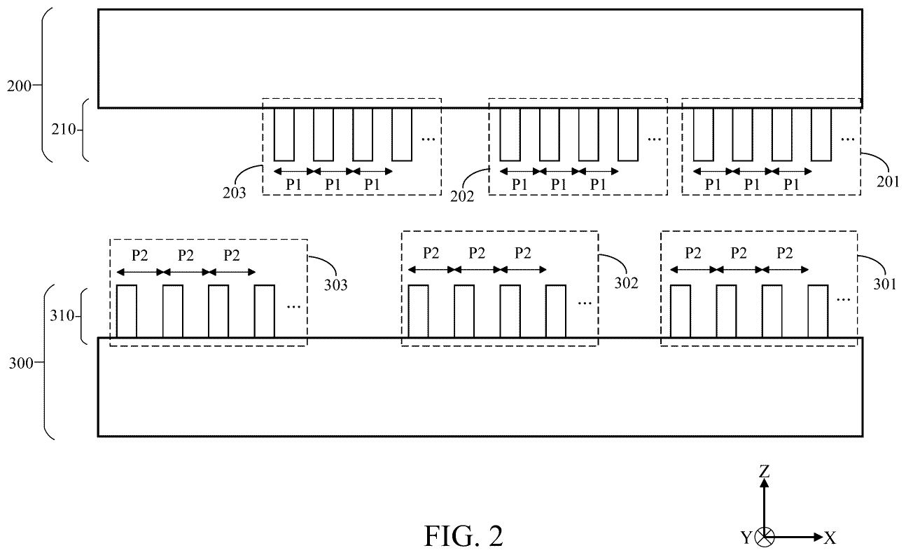

It should be noted that configurations such as heights, widths, quantities and spacings of the first grating 210 and the second grating 310, and the relative ratio between the optical waveguides and the first grating 210 and the second grating 310 in FIG. 1 are for illustrative purposes only and are not drawn to actual scale. A further description is to be provided below with reference to FIG. 2. Referring to FIG. 2, FIG. 2 is an enlarged schematic diagram of a grating of an optical waveguide according to an embodiment of the present invention.

In FIG. 1, when the projection light source 100 is implemented as a light source with a wavelength λ of 525 nanometers (nm), a first grating 210 in FIG. 2 may be implemented with a first period P1 of 380 nm and periodically arranged along a direction parallel to an X-axis in FIG. 2, and a second grating 310 may be implemented with a second period P2 of 430 nm and periodically arranged along the direction parallel to the X-axis in FIG. 2.

The arrangement periods of the first grating 210 and the second grating 310 described above are not limited to the foregoing implementations. However, it is considered that leakage of stray light from an optical waveguide to outside and interference with another optical waveguide should be reduced during transmission of a target image provided by the projection light source 100 inside a first optical waveguide 200 and a second optical waveguide 300. In an embodiment, an absolute value |P1−P2| of a difference between the first period P1 and the second period P2 is greater than 0, and |P1−P2| is less than or equal to one tenth of a wavelength of the projection light source 100, that is,

$$\vert P 1 - P 2 \vert \leq \frac{λ}{10} .$$

In FIG. 1 and FIG. 2, as an optical waveguide for protecting a grating structure and transmitting the target image, the first grating 210 may be arranged on a side of the first optical waveguide 200 facing away from the projection light source 100. As shown in FIG. 1, the projection light source 100 transmits the target image into the first optical waveguide 200 along a −Z-axis direction, and reaches the first grating 210 at the bottom of the first optical waveguide 200.

The first grating 210 is arranged in a first input coupling region 201, a first folding region 202, and a first output coupling region 203. The first input coupling region 201 reflects part of light provided by the projection light source 100 back into the first optical waveguide 200. The first folding region 202 changes a transmission direction of the light within the first optical waveguide 200. The first output coupling region 203 guides the light out of the first optical waveguide 200 to transmit the light to eyes of a user.

On the other hand, the second grating 310 is arranged on a side of the second optical waveguide 300 facing the first grating 210. The second grating 310 is arranged in the second input coupling region 301, the second folding region 302, and the second output coupling region 303. The part of the light provided by the projection light source 100 passes through the first optical waveguide 200 and enters the second input coupling region 301 of the second optical waveguide 300. The second input coupling region 301 guides light into the second optical waveguide 300 for transmission. The second folding region 302 changes a transmission direction of the light within the second optical waveguide 300. The second output coupling region 303 guides the light out of the second optical waveguide 300 to transmit the light to the eyes of the user.

The foregoing implementations of the input coupling region, the folding region, and the output coupling region may be implemented through different grating arrangement directions. In the input coupling regions in FIG. 1 and FIG. 2, the first grating 210 and the second grating 310 are arranged along a direction parallel to an X axis, and the first grating 210 and the second grating 310 extend along a direction parallel to a Y axis. In another embodiment, the first grating 210 and the second grating 310 extend in the direction configured on an X-Y plane and form an included angle of 45 degrees with the X-axis and the Y-axis. When the light provided by the projection light source 100 is transmitted along a direction parallel to a Z axis and incident onto the foregoing grating configured on the X-Y plane and having an included angle of 45 degrees between an extension direction and the X axis and the Y axis, the transmission direction of the light is changed from the direction parallel to the Z axis to a direction having a transmission component parallel to the X axis and the Y axis. Similarly, the arrangement of a grating direction in the folding region and the output coupling region is not described herein.

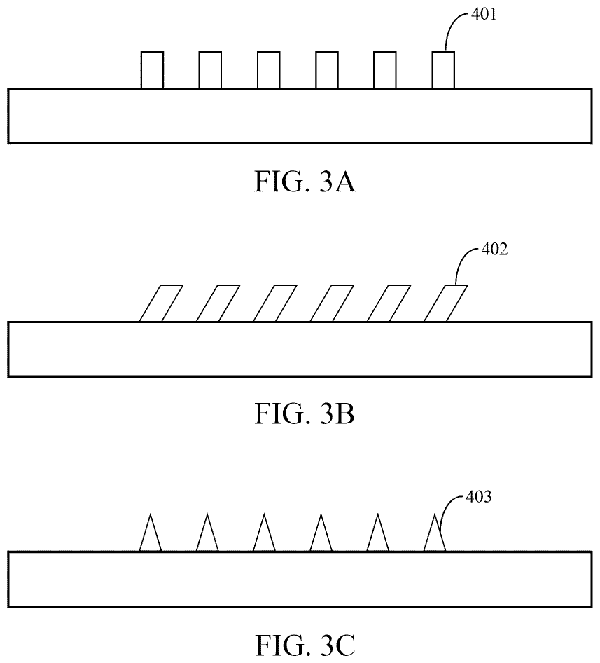

Further, the embodiment of the present invention is different from other conventional technologies in that the first grating 210 and the second grating 310 in the first optical waveguide 200 and the second optical waveguide 300 in the embodiments of the present invention can be configured to have a same grating structure. Referring to FIG. 3A to FIG. 3C, FIG. 3A to FIG. 3C are schematic diagrams of grating structures according to an embodiment of the present invention, where FIG. 3A shows a binary grating structure, FIG. 3B shows a slanted grating structure, and FIG. 3C shows a blazed grating structure.

In FIG. 1 and FIG. 2, the grating structures of the first grating 210 and the second grating 310 are implemented as a binary grating 401 as shown in FIG. 3A. However, the first grating 210 and the second grating 310 can further be implemented as the slanted grating 402 as shown in FIG. 3B, or implemented as the blazed grating 403 as shown in FIG. 3C. Therefore, in the embodiments of the present invention, only the grating structure in the optical waveguide needs to be implemented as a single structure, which is simpler in grating fabrication than other conventional technologies.

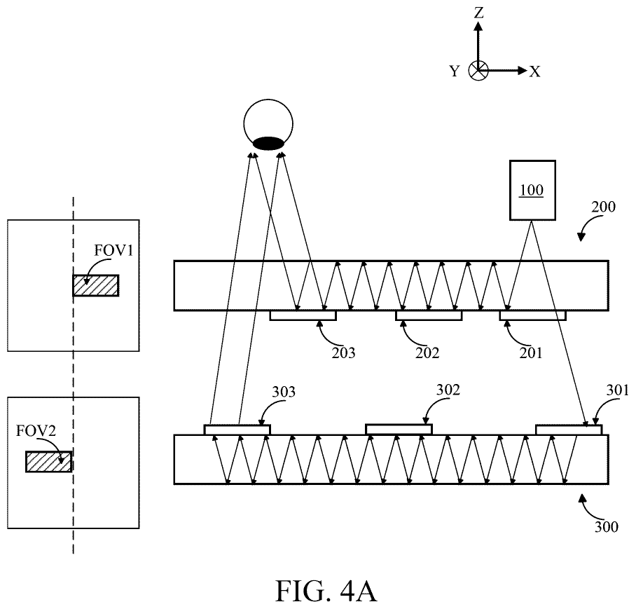

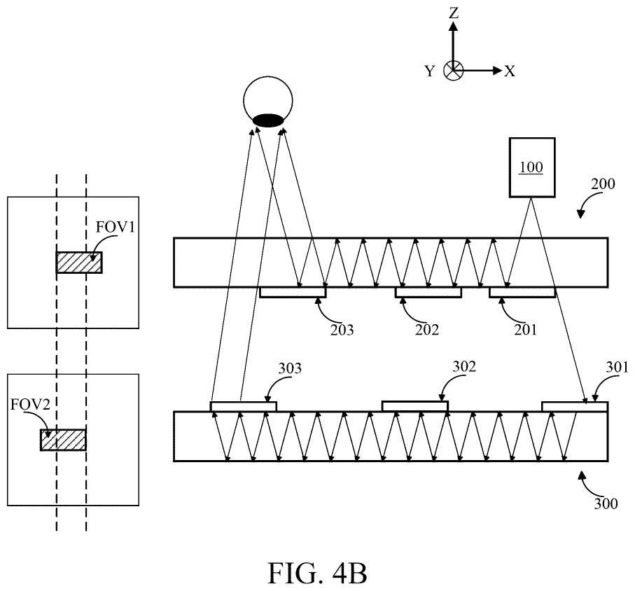

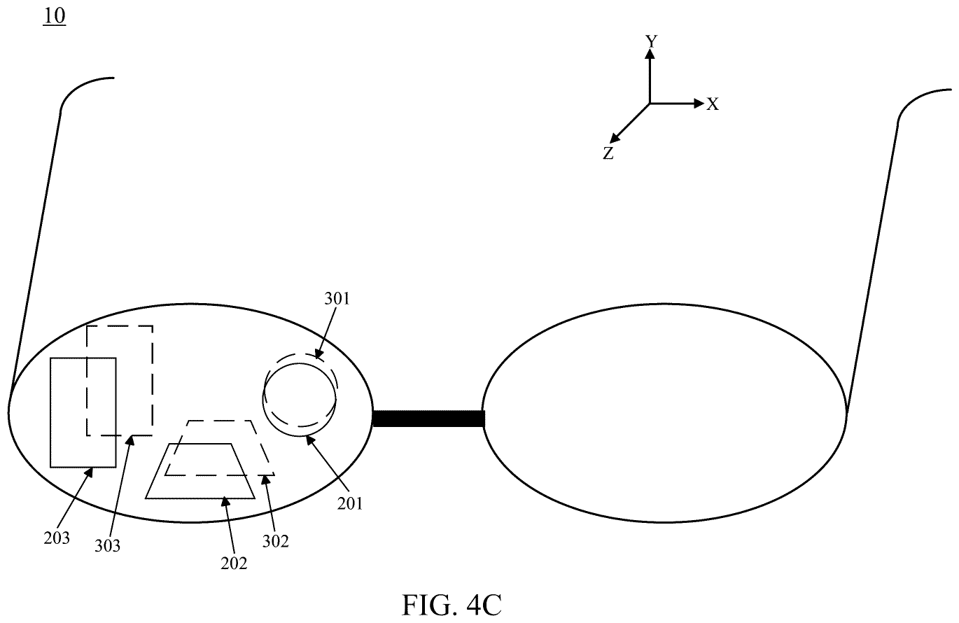

Considering a balance between brightness and a size of an FOV of a target image finally viewed by a user, relative positions of the input coupling regions, the folding regions, and the output coupling regions of the first optical waveguide 200 and the second optical waveguide 300 in the embodiments of the present invention can have different configurations. Referring to FIG. 4A to FIG. 4C, FIG. 4A is a schematic diagram of a first configuration and a size of an FOV of an input coupling region, a folding region, and an output coupling region according to an embodiment of the present invention, FIG. 4B is a schematic diagram of a second configuration and a size of an FOV of an input coupling region, a folding region, and an output coupling region according to an embodiment of the present invention, and FIG. 4C is a schematic top view of a percentage of overlap of an input coupling region, a folding region, and an output coupling region according to an embodiment of the present invention. It should be noted that for illustrative purposes, a schematic diagram indicated as a grating is omitted in FIG. 4A and FIG. 4B, and the input coupling region, the folding region, and the output coupling region are represented by schematic blocks.

In FIG. 4A and FIG. 4B, a first input coupling region 201 and a second input coupling region 301 have a first percentage of overlap in a direction (that is, a direction in which the projection light source 100 vertically projects a target image onto a first optical waveguide 200) parallel to a Z axis, and a first folding region 202 and a second folding region 302 have a second percentage of overlap in the direction parallel to the Z axis. In addition, a first output coupling region 203 and a second output coupling region 303 have a third percentage of overlap in the direction parallel to the Z axis.

In FIG. 4A, when the target image is transmitted from the first output coupling region 203 of the first optical waveguide 200 to eyes of a user, a size of an FOV of the target image viewed by the user is a first field of view FOV1 as shown in FIG. 4A. Similarly, when the target image is transmitted from the second output coupling region 303 of the second optical waveguide 300 to eyes of a user, a size of an FOV of the target image viewed by the user is a second field of view FOV2 as shown in FIG. 4A.

In FIG. 4A, the first output coupling region 203 and the second output coupling region 303 do not overlap in the direction parallel to the Z axis. In other words, the third percentage of overlap is 0%. In this case, the target image has no overlap between the first field of view FOV1 and the second field of view FOV2, and a combined target image viewed by the user has a largest size of the FOV. However, in consideration of the balance between the size of the FOV and brightness of the target image viewed by the user, the third percentage of overlap of the first output coupling region 203 and the second output coupling region 303 may have different configurations. In FIG. 4B, the first output coupling region 203 and the second output coupling region 303 have an overlap in the direction parallel to the Z axis. In other words, the third percentage of overlap is not 0%. In this case, the target image has an overlap between the first field of view FOV1 and the second field of view FOV2, and the user views a target image with a relatively narrow FOV and a relatively bright target image.

In FIG. 4C, as an embodiment of the present invention, the first percentage of overlap between the first input coupling region 201 and the second input coupling region 301 is preferably implemented as 60% to 100%, the second percentage of overlap between the first folding region 202 and the second folding region 302 is preferably implemented as 30% to 70%, and the third percentage of overlap between the first output coupling region 203 and the second output coupling region 303 is preferably implemented as 0% to 60%. In a preferred embodiment, the first percentage of overlap is greater than or equal to the second percentage of overlap, and the second percentage of overlap is greater than or equal to the third percentage of overlap.

The relationship between the foregoing size of the FOV and the third percentage of overlap substantially satisfies the following equation:

$${R}_{out} = \frac{F O {V}_{1} + F O {V}_{2} - F O {V}_{all}}{F O {V}_{all}} ,$$

where Rₒᵤₜ represents the third percentage of overlap, FOV1 represents an angle range of the first field of view FOV1, FOV2 represents an angle range of the second field of view FOV2, and FOVₐₗₗ represents an angle range of a combined FOV viewed by the user.

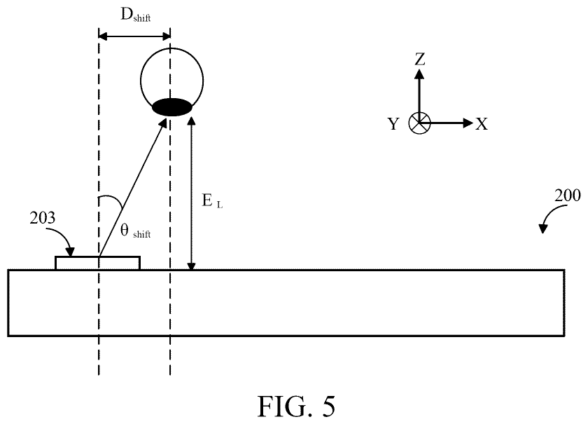

It should be noted that an angle at which the user views the output coupling region may be implemented as a specific included angle. Referring to FIG. 5, FIG. 5 is a schematic diagram of an included angle at which a user views an output coupling region according to an embodiment of the present invention. A direction in which the user vertically views a first optical waveguide 200 and a second optical waveguide 300 is a direction parallel to a Z axis, and a direction in which the user views a first output coupling region 203 or a second output coupling region 303 is the first direction, and an included angle θ_{shift} between a Z-axis direction and the first direction is greater than 0 degrees.

In an embodiment of the present invention, if a distance E_{L} between the eyes of the user and a surface of the first optical waveguide 200 is implemented as 20 millimeters (mm), and the included angle θ_{shift} is implemented as 8 degrees, the eyes of the user may be located at a distance of approximately tan (8°)×20 mm=2.81 mm by D_{shift} from the center of the first output coupling region 203. The technical effect of ensuring that the target image position does not occlude a forward line of sight of the user can be achieved.

The optical module 1 described above can also be implemented in augmented reality (AR) glasses 10 as shown in FIG. 4C, to serve as an AR display. The augmented reality (AR) display includes glasses 10 and an above optical module 1.

The above descriptions are merely some preferred embodiments of the present invention. It should be noted that various changes and modifications can be made to the present invention without departing from the spirit and principles of the present invention. A person of ordinary skill in the art should clearly understand that the present invention is defined by the appended patent application scope, and in accordance with the spirit of the present invention, various possible changes such as substitutions, combinations, modifications, and diversions are within the scope of the present invention as defined by the appended patent application scope.

What is claimed is:

1. An optical module, comprising:
a projection light source, configured to provide a target image;
a first optical waveguide, having a plurality of first gratings, wherein the plurality of first gratings are arranged at a distance of a first period; and
a second optical waveguide, having a plurality of second gratings, wherein the plurality of second gratings are arranged at a distance of a second period, and an absolute value of a difference between the first period and the second period is greater than 0 and less than or equal to one tenth of a wavelength of the target image.

2. The optical module according to claim 1, wherein the plurality of first gratings are located on a side facing away from the projection light source, and the plurality of second gratings face the plurality of first gratings.

3. The optical module according to claim 1, wherein refractive indexes of the first optical waveguide and the second optical waveguide are between 1.45 and 1.65.

4. The optical module according to claim 1, wherein the plurality of first gratings are arranged in a first input coupling region, a first folding region, and a first output coupling region, and the plurality of second gratings are arranged in a second input coupling region, a second folding region, and a second output coupling region;
wherein the first input coupling region and the second input coupling region have a first percentage of overlap in a direction in which the target image is vertically projected onto the first optical waveguide;
wherein the first folding region and the second folding region have a second percentage of overlap in a direction in which the target image is vertically projected onto the first optical waveguide, and the first percentage of overlap is greater than or equal to the second percentage of overlap; and
wherein the first output coupling region and the second output coupling region have a third percentage of overlap in the direction in which the target image is vertically projected onto the first optical waveguide, and the second percentage of overlap is greater than or equal to the third percentage of overlap.

5. The optical module according to claim 1, wherein the plurality of first gratings and the plurality of second gratings have a same grating structure.

6. The optical module according to claim 5, wherein the grating structure is a binary grating, a slanted grating, or a blazed grating.

7. The optical module according to claim 4, wherein the first percentage of overlap is in a range of 60% to 100%.

8. The optical module according to claim 4, wherein the second percentage of overlap is in a range of 30% to 70%.

9. The optical module according to claim 4, wherein the third percentage of overlap is in a range of 0% to 60%.

10. The optical module according to claim 4, wherein a direction in which a user views the first output coupling region or the second output coupling region is a first direction, a direction in which the user vertically views the first optical waveguide or the second optical waveguide is a second direction, and an included angle between the first direction and the second direction is greater than 0 degrees.

11. An augmented reality (AR) display, comprising:
a glasses; and
an optical module disposed on the glasses, comprising:
a projection light source, configured to provide a target image;
a first optical waveguide, having a plurality of first gratings, wherein the plurality of first gratings are arranged at a distance of a first period; and
a second optical waveguide, having a plurality of second gratings, wherein the plurality of second gratings are arranged at a distance of a second period, and an absolute value of a difference between the first period and the second period is greater than 0 and less than or equal to one tenth of a wavelength of the target image.

12. The augmented reality (AR) display according to claim 11, wherein the plurality of first gratings are located on a side facing away from the projection light source, and the plurality of second gratings face the plurality of first gratings.

13. The display according to claim 11, wherein the plurality of first gratings are arranged in a first input coupling region, a first folding region, and a first output coupling region, and the plurality of second gratings are arranged in a second input coupling region, a second folding region, and a second output coupling region, wherein the first input coupling region and the second input coupling region have a first percentage of overlap in a direction in which the target image is vertically projected onto the first optical waveguide.

14. The display according to claim 13, wherein the first folding region and the second folding region have a second percentage of overlap in a direction in which the target image is vertically projected onto the first optical waveguide, and the first percentage of overlap is greater than or equal to the second percentage of overlap, and wherein the first output coupling region and the second output coupling region have a third percentage of overlap in the direction in which the target image is vertically projected onto the first optical waveguide, and the second percentage of overlap is greater than or equal to the third percentage of overlap.

15. The display according to claim 14, wherein a direction in which a user views the first output coupling region or the second output coupling region is a first direction, a direction in which the user vertically views the first optical waveguide or the second optical waveguide is a second direction, and an included angle between the first direction and the second direction is greater than 0 degrees.
